(19) United States
(12) Patent Application Publication
(10) Pub. No.: US 2017/0076329 A1
(43) Pub. Date: Mar. 16, 2017

(54) Delivery Rate Control in a Video Delivery System

(71) Applicant: HULU, LLC, Santa Monica, CA (US)

(72) Inventors: Andrew Waag, San Luis Obispo, CA (US); Fangcheng Sun, Irvine, CA (US)

(21) Appl. No.: 14/855,985

(22) Filed: Sep. 16, 2015

(51) Int. Cl. G06Q 30/02

(52) U.S. Cl. CPC G06Q 30/0264

(57) ABSTRACT

In one embodiment, a method calculates a delivery pressure for a first advertisement in a list of advertisements that qualified for an advertisement slot in a media program. The delivery pressure is based on a number of advertisement impressions in the campaign that is remaining, a share of voice for the first advertisement, and a volume of impressions that are remaining for the campaign. The method also determines when the delivery pressure indicates a pressure to deliver the first advertisement is below a threshold. A status is adjusted for an eligibility of the first advertisement to be delivered from a first state to a second state when the delivery pressure is below the threshold. The first state does not enable rate control and the second state enables rate control. The method then selects at least one advertisement from the list of advertisements for the advertisement slot.

### BACKGROUND

In an advertising (ad) campaign, an advertiser may specify parameters that control delivery of advertisements for the campaign within a time range. For example, the advertiser may desire N number of impressions over a month. A video delivery service can then attempt to deliver the N number of impressions for the advertisement over the month. While the video delivery service plays videos for users, ad slots occur in which the video delivery service has an opportunity to insert an advertisement. When the opportunity occurs, an advertisement server for the video delivery service may select from a list of qualified advertisements. Once making the selection, the advertisement server has the selected advertisement delivered during the ad slot, which is considered an ad impression for the selected advertisement and campaign.

The delivery of advertisements for the campaign may not be evenly distributed over the time range. For example, the advertisement server may want to deliver 1,000 impressions of a specific advertisement per hour. However, the advertisement server typically does not know how many times the advertisement has been delivered that hour. Thus, the advertisement server may over-deliver the specific advertisement. For example, the advertisement server may deliver 25,000 impressions of the specific advertisement during the hour even though only 1,000 were desired. Then, once the ad impression data is reviewed for that hour, it may be determined that all of the required ad impressions for the day have been delivered in 1 hour. Thus, the video delivery service may attempt to not deliver any more advertisements for the rest of the day. This may be undesirable as the advertiser would like the viewing of the specific advertisement to be spaced somewhat evenly throughout the day.

### SUMMARY

In one embodiment, a method provides rate control for a first advertisement in a campaign. The method calculates a delivery pressure for a first advertisement in a list of advertisements that qualified for an advertisement slot in a media program. The delivery pressure is based on a number of advertisement impressions in the campaign that is remaining, a share of voice for the first advertisement, and a volume of impressions that are remaining for the campaign. The method also determines when the delivery pressure indicates a pressure to deliver the first advertisement is below a threshold. A status is adjusted for an eligibility of the first advertisement to be delivered from a first state to a second state when the delivery pressure is below the threshold. The first state does not enable rate control and the second state enables rate control to control delivery of the first advertisement due to the delivery pressure. The method then selects at least one advertisement from the list of advertisements for the advertisement slot. The selecting is performed with rate control enabled based on the first advertisement having the second state as the status.

In one embodiment, a non-transitory computer-readable storage medium contains instructions for providing rate control for a first advertisement in a campaign, wherein the instructions, when executed, control a computer system to be configured for: calculating a delivery pressure for a first advertisement in a list of advertisements that qualified for an advertisement slot in a media program, the delivery pressure based on a number of advertisement impressions in the campaign that is remaining, a share of voice for the first advertisement, and a volume of impressions that are remaining for the campaign; determining when the delivery pressure indicates a pressure to deliver the first advertisement is below a threshold; adjusting a status for an eligibility of the first advertisement to be delivered from a first state to a second state when the delivery pressure is below the threshold, wherein the first state does not enable rate control and the second state enables rate control to control delivery of the first advertisement due to the delivery pressure; and selecting at least one advertisement from the list of advertisements for the advertisement slot, wherein the selecting is performed with rate control enabled based on the first advertisement having the second state as the status.

In one embodiment, an apparatus for providing rate control for a first advertisement in a campaign includes: one or more computer processors; and a non-transitory computer-readable storage medium comprising instructions, that when executed, control the one or more computer processors to be configured for: for providing rate control for a first advertisement in a campaign, wherein the instructions, when executed, control a computer system to be configured for: calculating a delivery pressure for a first advertisement in a list of advertisements that qualified for an advertisement slot in a media program, the delivery pressure based on a number of advertisement impressions in the campaign that is remaining, a share of voice for the first advertisement, and a volume of impressions that are remaining for the campaign; determining when the delivery pressure indicates a pressure to deliver the first advertisement is below a threshold; adjusting a status for an eligibility of the first advertisement to be delivered from a first state to a second state when the delivery pressure is below the threshold, wherein the first state does not enable rate control and the second state enables rate control to control delivery of the first advertisement due to the delivery pressure; and selecting at least one advertisement from the list of advertisements for the advertisement slot, wherein the selecting is performed with rate control enabled based on the first advertisement having the second state as the status.

The following detailed description and accompanying drawings provide a better understanding of the nature and advantages of particular embodiments.

### BRIEF DESCRIPTION OF THE DRAWINGS

FIG. 1 depicts a simplified system for delivering advertisements using a delivery pressure according to one embodiment.

FIG. 2 depicts a more detailed example of an ad server according to one embodiment.

FIG. 3A depicts an example of the list of advertisements according to one embodiment.

FIG. 3B depicts another example of the list of advertisements according to one embodiment.

FIG. 4 depicts an example of the different levels of rate control that can be performed according to one embodiment.

FIG. 5 depicts a simplified flowchart of a method for performing the rate control according to one embodiment.

FIG. 6 depicts a simplified flowchart of a method for performing of the rate control according to one embodiment.

FIG. 7 depicts an example for performing rate control in an ad selector according to one embodiment.

FIG. 8 depicts a video streaming system in communication with multiple client devices via one or more communication networks according to one embodiment.

FIG. 9 depicts a diagrammatic view of an apparatus for viewing video content and advertisements.

### DETAILED DESCRIPTION

Described herein are techniques for providing rate control in a video delivery system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Particular embodiments enhance an advertisement server that selects an advertisement to deliver during an advertisement (ad) slot. The advertisement server calculates a delivery pressure for an advertisement in an advertisement campaign. The delivery pressure may be based on a number of variables in a delivery pressure calculation. The variables include a number of advertisement impressions in the advertisement campaign remaining, a share of voice for the advertisement, and a volume of impressions that is remaining for the campaign. The delivery pressure for the advertisement may be analyzed to determine when to change a status of the advertisement. The status may be changed such that the advertisement server applies dynamic rate control to the advertisement. For example, when pressure to deliver the advertisement is below a threshold (e.g., the pressure to deliver an ad impression is low), the advertisement server may activate dynamic rate control throttling. This may cause the advertisement server to select the advertisement for delivery less while the rate control is enabled. In one embodiment, the advertisement may still qualify in a list for possible delivery for an ad slot, but the changed status will filter the advertisement out and not allow it to be selected for delivery by the advertisement server. This results in the advertisement not actually being able to be delivered for that ad slot. When pressure to deliver the advertisement is above a threshold (e.g., the pressure to deliver an ad impression is high), the advertisement server disables the rate control throttling and does not employ any rate control throttling.

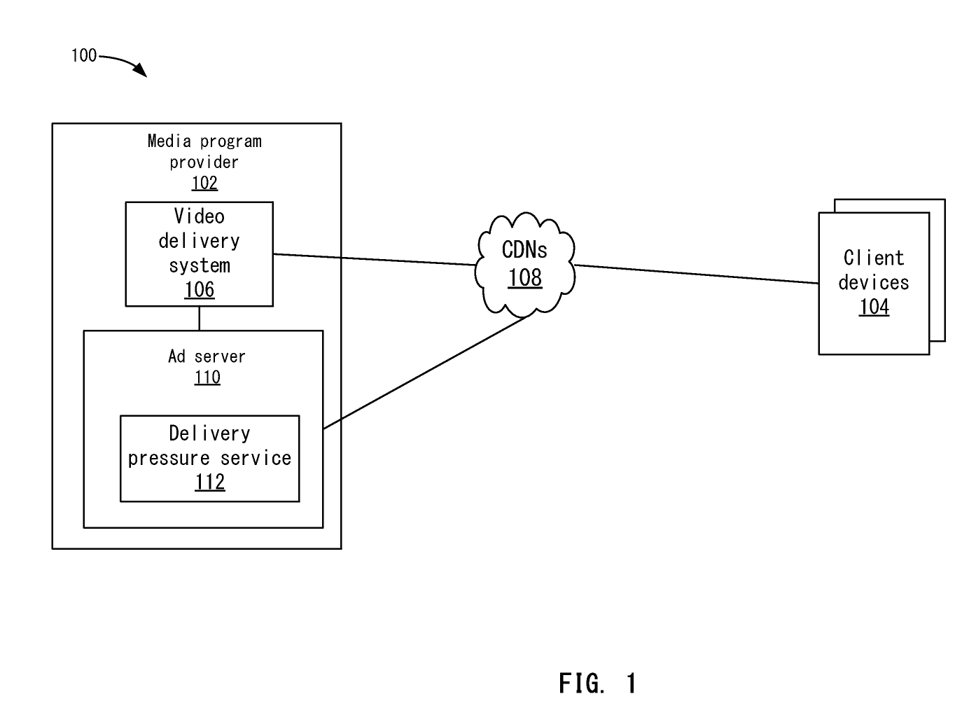

FIG. 1 depicts a simplified system 100 for delivering advertisements using a delivery pressure according to one embodiment. System 100 includes a media program provider 102 and client devices 104.

Media program provider 102 may be a video delivery service that allows client devices 104 to request videos on-demand. For example, media program provider 102 includes a video delivery system 106 that can coordinate the delivery of videos to client devices 104 through content delivery networks 108. Content delivery networks 108 may be a separate entity from media program provider 102 and help facilitate the delivery of the videos for a fee. In other embodiments, video delivery system 106 can deliver the videos to client devices 104 without using content delivery networks 108.

Client devices 104 may include different computing devices, such as mobile devices including smartphones and tablet devices, laptop computers, televisions, living room devices, such as gaming consoles, and other devices that can display videos on other display devices. Client devices 104 may request a video from video delivery system 106. Video delivery system 106 may use different protocols to provide the video to client devices 104. In a live streaming example, video delivery system 106 sends a set of addresses to client devices 104 for the video. Client devices 104 then use the set of addresses to request portions of the video from content delivery networks 108. Other methods to deliver the video may also be used.

At points before, within, or after the playing of the video, ad slots may occur in which advertisements may be inserted for viewing by a user on client devices 104. When an ad slot occurs, client devices 104 may send a request for an advertisement to video delivery system 106. Then, media program provider 102 selects an advertisement for that ad slot.

In one embodiment, media program provider 102 may use an advertisement (ad) server 110 that can select the advertisement for the ad slot. Ad server 110 may use an algorithm to select the advertisement for the ad slot that is based on different parameters. For example, ad server 110 may first determine a list of advertisements that qualify for the ad slot. The qualification may be based on targeting characteristics. For example, the targeting characteristics for the ad slot may be user characteristics, such as male aged 18-49 or female aged 18-49, but other characteristics may be used. Only some of the advertisements may be designated as targeted to that group of characteristics, and ad server 110 selects those advertisements as being qualified for the ad slot.

Once the list of advertisements is selected, ad server 110 selects one of the advertisements in the list for delivery during the ad slot. Various ways of delivering advertisements to client device 104 may be appreciated. For example, video delivery system 106 may then send the address for the advertisement to client device 104, which uses the address to request the advertisement. In another example, ad server 110 may deliver the advertisement to client device 104. In other embodiments, client device 104 may request the advertisement from content delivery networks 108.

Ad server 110 includes a delivery pressure service 112 that can calculate a delivery pressure for advertisements. Ad server 110 uses the delivery pressure to determine whether advertisements are allowed to be delivered. Delivery pressure service 112 may calculate the delivery pressure based on a pressure calculation that uses variables for a campaign, such as a number of advertisement impressions in the campaign remaining (n), a share of voice for the advertisement (T), a volume of impressions that is remaining for the campaign (V), and a constant (R). This may be similar to calculating the pressure using an ideal gas law. For example, the equation used to calculate the pressure is P=(nRT)/V. In this case, the idea of pressure is similar to the ideal gas law. Also, although the constant is described, it may not be used in some embodiments.

The delivery pressure may be similar to a check value, which may be used to regulate a pressurized flow. Delivery pressure service 112 uses the delivery pressure to provide rate control, and in one embodiment, regulate the advertisement flow for an advertisement campaign. The delivery pressure is not only determined by the number of impressions that still need to be served for the campaign, but also influenced by the amount of time remaining for the campaign, the initial size of the impression goal for the advertisement campaign, and the scarcity of ad inventory relative to the ad targeting.

The number of advertisement impressions in the campaign remaining (n) may be the number of impressions that still need to be delivered to meet the advertisement campaign's goal. For example, the goal may be to deliver 100,000 impressions over a month. If 50,000 impressions have been delivered, then the number of advertisement impressions remaining is 50,000. The campaign may include a single advertisement that is to be delivered 100,000 times, or may include multiple advertisements that in total are to be delivered 100,000 times. The campaign may also be broken down into smaller time granularities, such as for the 1 month advertisement campaign, the goal may be to deliver 25,000 impressions per week.

The share of voice (T) may be the total impressions delivered for the campaign divided by the total size of the inventory pool with the same targeting characteristics. That is, if there are 1,000,000 chances to deliver an impression for the targeting characteristics, and 100,000 impressions of the advertisement for the campaign get delivered within those 1,000,000 chances, then this advertisement's share of voice is 100,000/1,000,000=1/10. The targeting characteristics may be a specific set of targeting characteristics, such as males aged 18-49 or females aged 18-49.

The volume may theoretically decay with time unless other adjustments to the advertisement campaign occur. For example, the volume may be based on a time unit delivery goal and the number of time units remaining before the ad campaign expires. In one example, the volume may be an hourly delivery goal multiplied by the hours remaining before the ad campaign expires. In this way, the volume may be calculated as the area of the face times the height where the area of the face is the hourly delivery goal and the height is the hours remaining before the placement expires. Time units other than an hour may also be appreciated.

R is a constant that may be value that is determined such that is may provide a smooth pacing time goal. The constant may be determined such that delivery of the advertisements for the campaign is more evenly distributed (e.g., paced) over a time range, such as an hour.

Particular embodiments use the delivery pressure to correct unintentional over-delivery. Ad servers were prone to over-deliver since the ad server could not see how many impressions were being served in real-time. Delivery pressure service 112 alleviates this situation by allowing impressions to serve based on the pressure that a campaign has to deliver for an advertisement.

The higher the number of advertisement impressions that need to deliver and a higher share of voice will theoretically lead to an increase in delivery of the advertisement. This is dependent on volume where a lower volume of advertisement impressions left to serve will increase delivery since the pressure is increased. Likewise, a high volume of advertisement impressions left to serve will decrease pressure to serve advertisements. Reviewing the pressure calculation, the number of advertisement impressions that need to deliver and a higher share of voice are in the numerator of the equation and higher values of these variables increase the pressure. A larger volume, which is based on the time remaining, lowers the pressure because this variable is in the denominator of the pressure equation. When the share of voice is high, it may not be desirable to forego delivering impressions for the campaign. This is because it will be hard to make up those impressions at a later time. This is because it may be hard to get to that large of share of voice in the future. This is why the pressure is higher when the share of voice is higher.

### Ad Server

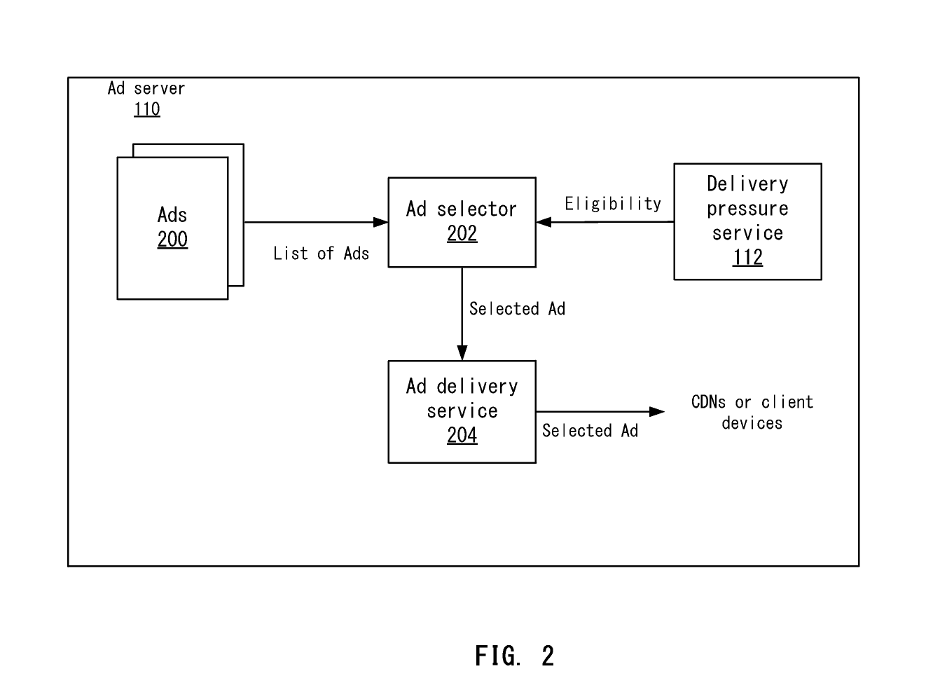

FIG. 2 depicts a more detailed example of ad server 110 according to one embodiment. Ad server 110 includes an ad selector 202, an ad delivery service 204, and delivery pressure service 112. Ad selector 202 may determine a list of advertisements from ads 200 that are available. The list of advertisements are advertisements that qualify for the ad slot. The qualification may be based on targeting characteristics (or none in some cases). For example, for given set of targeting characteristics, ad selector 202 determines the list of ads, which may be a list of identifiers for ads that qualify for delivery in the ad slot.

Delivery pressure service 112 may also provide a status for advertisements on the list. The status may include different statuses, such as a first status where no rate control is associated with an advertisement, and also a second status in which rate control is associated with the advertisement. Different levels of rate control may also be used. The first status of not including rate control means that there are no limitations on the selection of the advertisement from the list for delivery based on the delivery pressure. This may mean that the pressure to deliver is high. If the second status is associated with an advertisement, then ad selector 202 may apply some type of rate control. This means that the pressure to deliver is low, and delivering the advertisement for this ad slot is not very high.

In one embodiment, the rate control may limit the amount of times the advertisement is eligible to be delivered even though the advertisement qualified for the list. For example, even though the advertisement is on the list, ad selector 202 is restricted from selecting it for delivery. If rate control is applied, the advertisement may be removed from being eligible a certain percentage of the times the advertisement is qualified for delivery over a time period. Particular embodiments may allow advertisements to qualify for the list so the video delivery service knows how many times the advertisement would have qualified due to targeting. However, the use of the rate control removes the advertisement from being selected for delivery, which ensures that the advertisement will not be over-delivered. That is, if the rate control told ad selector 202 that it can attempt to deliver the advertisement 10% of the time, this may result in over-delivering because ad selector 202 may not have real-time updates for the delivery. That is, an algorithm operates with a 10% delivery control, but does not know if it has reached the 10% delivery in real-time can thus over-deliver the advertisement. By removing the advertisement from being eligible for delivery, delivery pressure service 112 ensures that over-delivery does not occur. Thus, ad server 110 does not use an algorithm with a delivery goal to select the advertisement from the list when using rate control.

Once ad selector 202 selects an advertisement from the list, ad delivery service 204 may provide the advertisement to client device 104. Ad delivery service 204 may have the advertisement delivered to client device 104 in different ways. As discussed above, an address for the advertisement may be sent to client device 104 and client device 104 can use that address to request the advertisement from a content delivery network 108. Ad server 110 may also directly send the advertisement to client device 104.

### List of Advertisements Example

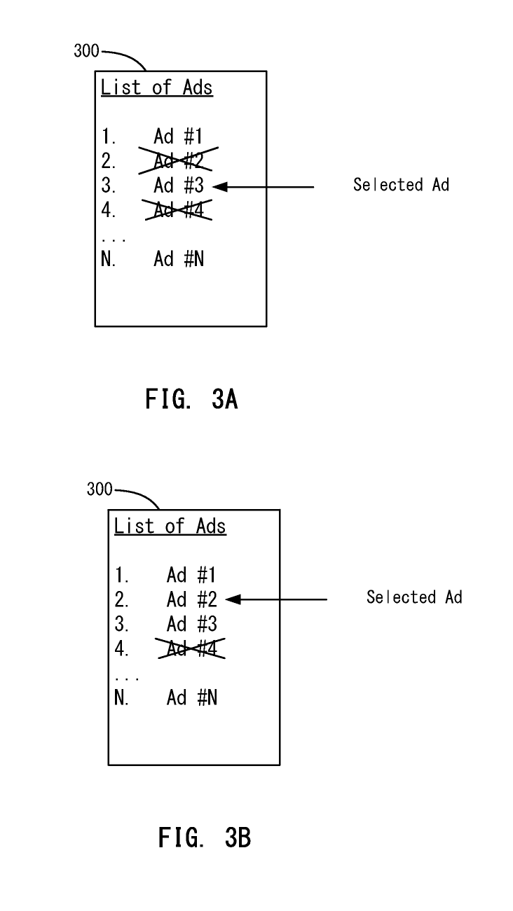

FIG. 3A depicts an example of the list of advertisements according to one embodiment. As shown, at 300 a list of advertisements #1, #2, #3, #4, . . . , #N have been selected as qualifying for the ad slot based on the targeting characteristics. Normally, all of these advertisements would be eligible for selection for the ad slot. However, dynamic rate control may be associated with any number of these advertisements.

In one embodiment, advertisements #2 and #4 have dynamic rate control associated with them. In this case, ad selector 202 takes advertisements #2 and #4 out of the running for being selected for delivery. Thus, ad selector 202 can select from advertisements #1, #3, and #N. Given that advertisements #2 and #4 are ineligible, in this case, ad selector 202 may select advertisement #3 for delivery during the ad slot.

The determination as to when to remove an advertisement from the selection process may be based on the rate control setting. In one embodiment, when on rate control, delivery pressure service 112 may probabilistically determine whether remove the advertisement from being eligible for a given time unit based on the delivery pressure. For example, if the delivery pressure is really low, then delivery pressure service 112 may decide that the advertisement should be ineligible for a majority of the time units in a time period (e.g., ineligible for 66% of the seconds in each minute). However, if the delivery pressure is somewhat higher, but still below the threshold, then delivery pressure service 112 may determine that the advertisement is eligible for a higher percentage of the time period (e.g., ineligible for 33% of the seconds in each minute).

Using the above example, at this given second, delivery pressure service 112 had decided that advertisements #2 and #4 are restricted from delivery. This may be the case no matter if advertisements #2 and #4 qualify for delivery at that second. However, given the scale of the video delivery service, it may be most likely, advertisements #2 and #4 qualify every second. At other times, delivery pressure service 112 may allow advertisements #2 and/or #4 to be eligible. FIG. 3B depicts another example of the list of advertisements according to one embodiment. This list may be for another ad slot at another time. In this list, delivery pressure service 112 has determined that advertisement #2 is eligible, but advertisement #4 is still not eligible. In this case, it is possible that ad server 110 would select advertisement #2.

### Rate Control Thresholds

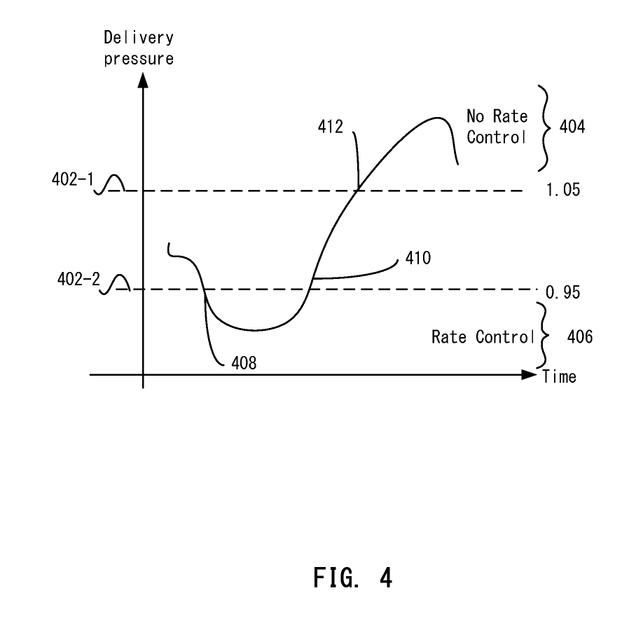

FIG. 4 depicts an example of the different levels of rate control that can be performed according to one embodiment. Two thresholds may be shown at 402-1 and 402-2. These may correspond to delivery pressure scores of 1.05 and 0.95. If the delivery pressure score is above 1.05 at 404, then delivery pressure service 112 may not enact any rate control. If the delivery pressure score is below 0.95 as shown at 406, then delivery pressure service 112 may enable the rate control for the advertisement. Different levels of rate control may be provided below 0.95. For example, if the delivery pressure score is 0.20, then delivery pressure service 112 may remove the advertisement from being delivered a high percentage of the time, such as 90% of the time. If the delivery pressure score is 0.80, then the advertisement may be removed a lower amount of the time, such as only 20% of the time.

Over time, the delivery pressure changes as shown by the graph. At 408, the delivery pressure as gone below 0.95 and delivery pressure service 112 can enable rate control throttling. As the delivery pressure further dips, delivery pressure service 112 may increase the amount of rate control throttling. The delivery pressure may then go above the 0.95 threshold at 410. However, some hysteresis may be built in where the rate control is not disabled until the delivery pressure goes above the 1.05 threshold. Once the delivery pressure goes back above 1.05 as shown at 412, then the rate control will be turned off. The rate control may continue until 1.05 is reached, or in other embodiments, the rate control is turned off when the 0.95 level is reached again. Although this scheme of rate control is described, this is just one example of applying the dynamic rate control.

### Method Flows

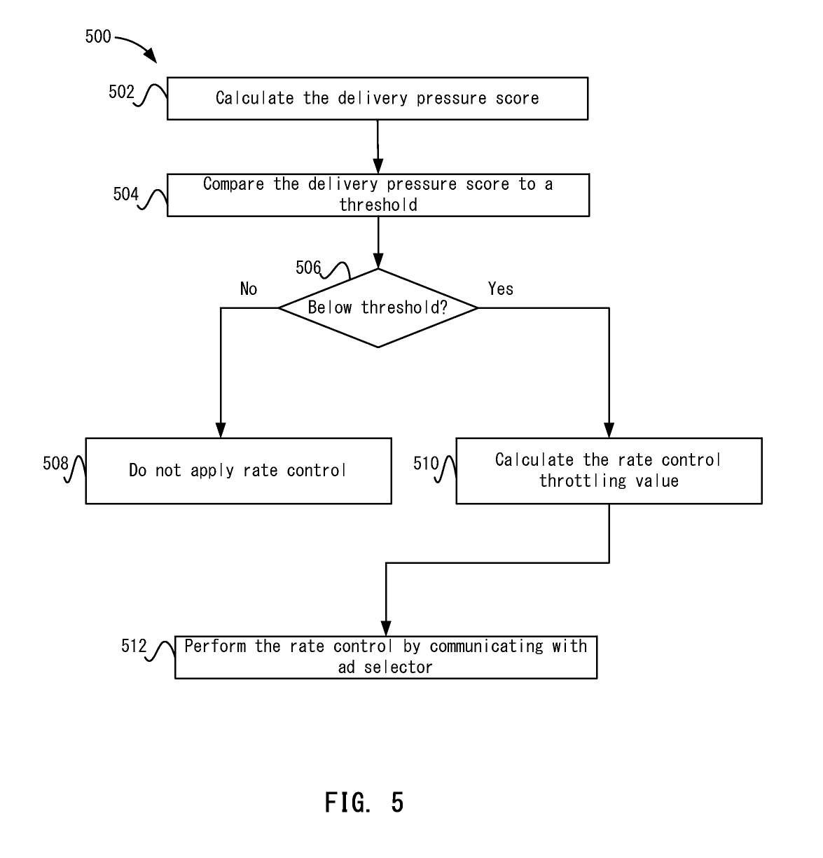

FIG. 5 depicts a simplified flowchart 500 of a method for performing the rate control according to one embodiment. At 502, delivery pressure service 112 calculates the delivery pressure score. The delivery pressure score may be continuously updated. For example, if the advertisement ineligibility is based on a granularity of seconds, then the delivery pressure score may be updated every second. The delivery pressure score uses an accumulated impression number to calculate the delivery pressure. Ad server 110 does not know the real-time impression number within the hour, minute or second. However, using the accumulated impression number with the delivery pressure score allows ad server 110 to perform rate control within the hour, minute, or second without knowing the real-time impression number. This may allow for better control of impressions.

At 504, delivery pressure service 112 compares the delivery pressure score to a threshold or thresholds (high and low). For this example, only one threshold is being described, which may be the only threshold used, or may be the low threshold at 0.95 as shown in FIG. 4. At 506, if the delivery pressure score is above the rate control threshold, then rate control is not applied at 508. However, at 510, if the delivery pressure score is below the rate control threshold, then delivery pressure service 112 calculates the rate control throttling value. The rate control may be calculated as described above with respect to FIG. 4 and may be a percentage of time that the advertisement is removed from being eligible for delivery. At 512, delivery pressure service 112 performs the rate control by communicating with ad selector 202. In this example, delivery pressure service 112 may make the advertisement ineligible for being delivered from a list of advertisements a certain amount of time based on the delivery pressure score.

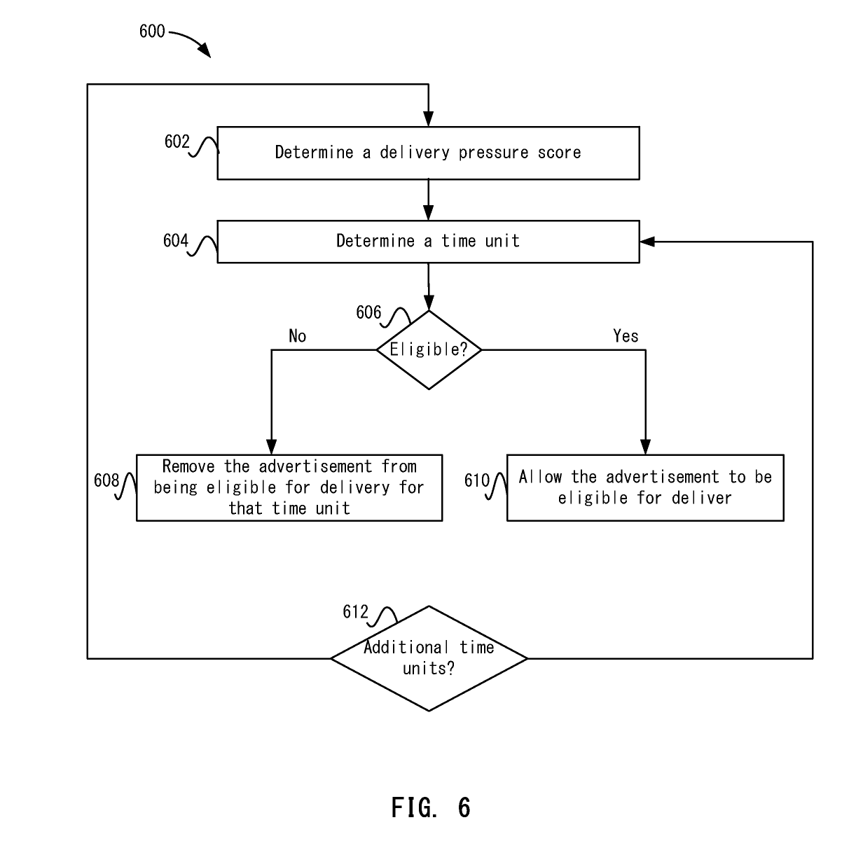

FIG. 6 depicts a simplified flowchart 600 of a method for performing of the rate control according to one embodiment. At 602, delivery pressure service 112 determines a delivery pressure score. This delivery pressure score is valid for a certain range of time, such as one minute, one hour, one day, etc.

At 604, delivery pressure service 112 determines a time unit. For example, a time unit may be every second, every minute, etc. Also, a time unit may be when an ad slot is encountered. However, when video delivery service 106 is serving advertisements to many different clients, ad slots may occur every single second. Other time granularities may also be appreciated.

At 606, delivery pressure service 112 determines if the advertisement should be eligible based on the delivery pressure score. For example, the delivery pressure score may be mapped to a percentage of time units the advertisement should be eligible. This may be a randomized process in which within the time range, the advertisement will be eligible 70% of the time, but the 70% of the time that the advertisement is eligible is randomly determined.

At 608, if the advertisement is not eligible, then delivery pressure service 112 removes the advertisement from being eligible for delivery for that time unit. In this case, ad selector 202 cannot select the advertisement for delivery.

At 610, if delivery pressure service 112 determines the advertisement is eligible, then delivery pressure service 112 allows the advertisement to be eligible for delivery. In this case, ad selector 202 may select the advertisement for delivery. However, because the advertisement is in a list of advertisements, the advertisement still may not be selected for delivery in this time unit.

At 612, delivery pressure service 112 determines if additional time units are found in the time range. If so, the process reiterates to 604 in which another time unit is determined. This may be another second. If there are no more time units, then the process reiterates to 602 where another delivery pressure score is determined. Then the process starts over for the next time range.

### Rate Control Example

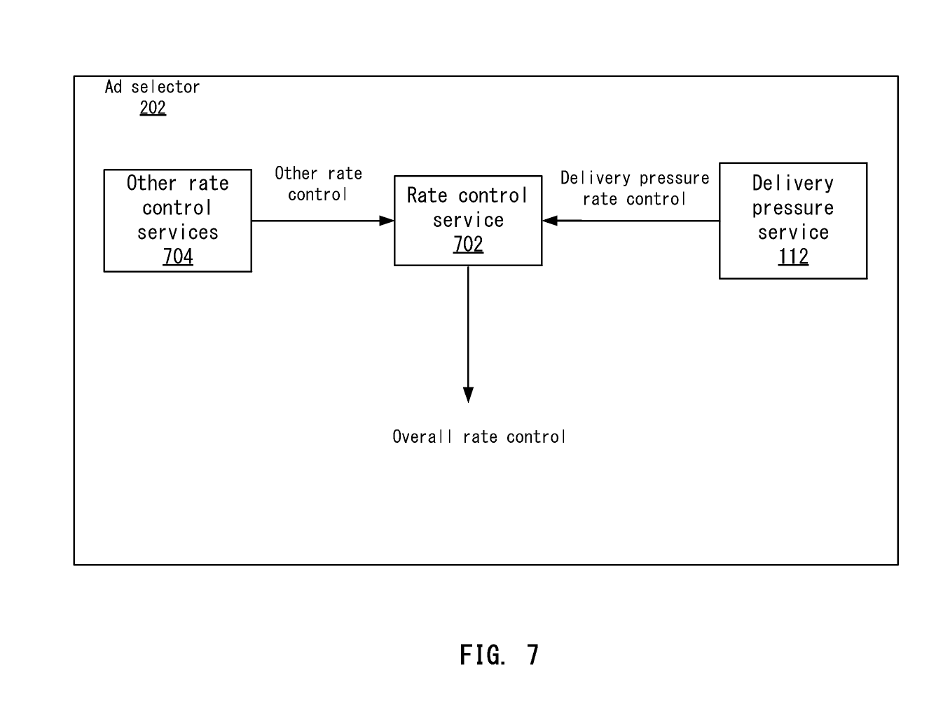

FIG. 7 depicts an example for performing rate control in ad selector 202 according to one embodiment. Ad selector 202 may employ different rate controls based on different algorithms. For example, other rate control services 704 may provide rate control for campaigns. Also, delivery pressure service 112 may provide rate control that can be implemented as discussed above with respect to FIGS. 5 and 6. In this case, delivery pressure service 112 may provide every second whether or not an advertisement for a campaign should be eligible for delivery or not. Rate control service 702 may then use the other rate control services and the delivery pressure rate control to determine an overall rate control. For example, the delivery pressure rate control may override all other rate control commands. Rate control service 602 may then output the overall rate control for use in selecting the advertisement from the list of advertisements.

In one example, the total campaign goal may be 1,000,000 impressions over a month. The hourly goal may be around 1389 impressions assuming 720 hours in a month. The share of voice may be 20% or 0.2. The constant may be “2”, but could be other numbers. The delivery pressure at the outset may be P=(1,000,000*2*0.2)/(1389*720)=0.4. This is a low pressure and rate control may be enabled. During the campaign, the volume drops and also the ad delivery drops. For example, at some point, the number of impressions remaining is 700,000, and the share of voice is 80% and volume is now 547,600. The pressure is now P=(400,000*2*0.8)/(547,600)=1.16. This is a high pressure and rate control is not enabled. The pressure may be high due to share of voice being high and also the volume being lower. This means that the campaign is taking a large amount of the available ad inventory and it is desirable to take the impressions now as it may be harder later to get impressions when the share of voice goes down. Further, the volume has gone down due to the time elapsing in the campaign further increasing the pressure to deliver impressions before the end.

Certain changes to the campaign while it is running may affect the delivery pressure. For example, adding more required impressions may make the delivery pressure higher.

Also, when the number of impressions is cut, the campaign may be overpacing due to the number of impressions being reduced. However, the advertiser may want the campaign to continue to serve advertisements at the same pace. Front-loading may also be used to take the campaign off rate control. When a campaign is over-pacing and the budget is cut, that means the number of ads remaining decreases. The decreased number of ads remaining puts less pressure on the delivery pressure score. This is because the number of ads remaining is in the numerator of the equation. This allows fewer advertisements to be eligible for delivery and ultimately serve. When fewer advertisements serve, delivery pressure service 112 may front-load the campaign to alert ad server 110 where the pacing is desired. The purpose of front-loading in this instance is not to deliver a high number of impressions of the advertisement, but to inform ad server 110 where is desired in terms of delivery. 80% of the ad impressions may have already been delivered but setting the front loading to 75% to tell ad server 110 this is the desired point may be used. The front loading shrinks the volume of impressions, which increases the pressure. When this occurs, delivery pressure service 112 may work with a more condensed volume of impressions and take the campaign off rate control. This may serve impressions more evenly for the remainder of the campaign.

### System Overview

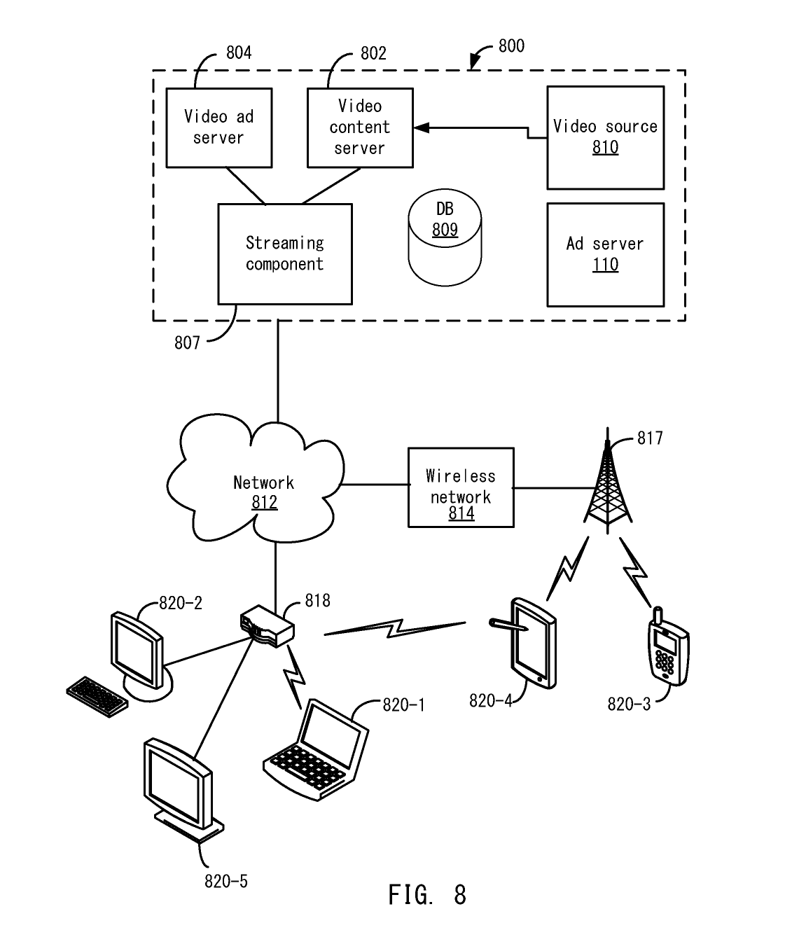

Features and aspects as disclosed herein may be implemented in conjunction with a video streaming system 800 in communication with multiple client devices via one or more communication networks as shown in FIG. 8. Aspects of the video streaming system 800 are described merely to provide an example of an application for enabling distribution and delivery of content prepared according to the present disclosure. It should be appreciated that the present technology is not limited to streaming video applications, and may be adapted for other applications and delivery mechanisms.

In one embodiment, a media program provider may include a library of media programs. For example, the media programs may be aggregated and provided through a site (e.g., Website), application, or browser. A user can access the media program provider's site or application and request media programs. The user may be limited to requesting only media programs offered by the media program provider.

In system 800, video data may be obtained from one or more sources for example, from a video source 810, for use as input to a video content server 802. The input video data may comprise raw or edited frame-based video data in any suitable digital format, for example, Moving Pictures Experts Group (MPEG)-1, MPEG-2, MPEG-4, VC-1, H.264/Advanced Video Coding (AVC), High Efficiency Video Coding (HEVC), or other format. In an alternative, a video may be provided in a non-digital format and converted to digital format using a scanner and/or transcoder. The input video data may comprise video clips or programs of various types, for example, television episodes, motion pictures, and other content produced as primary content of interest to consumers. The video data may also include audio or only audio may be used.

The video streaming system 800 may include one or more computer servers or modules 802, 804, and/or 807 distributed over one or more computers. Each server 802, 804, 807 may include, or may be operatively coupled to, one or more data stores 809, for example databases, indexes, files, or other data structures. A video content server 802 may access a data store (not shown) of various video segments. The video content server 802 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 804 may access a data store of relatively short videos (e.g., 10 second, 30 second, or 60 second video advertisements) configured as advertising for a particular advertiser or message. The advertising may be provided for an advertiser in exchange for payment of some kind, or may comprise a promotional message for the system 800, a public service message, or some other information. The video advertising server 804 may serve the video advertising segments as directed by a user interface controller (not shown).

The video streaming system 800 also may include ad server 110. Ad server 110 interacts with other components of the video streaming system and advertising system.

The video streaming system 800 may further include an integration and streaming component 807 that integrates video content and video advertising into a streaming video segment. For example, streaming component 807 may be a content server or streaming media server. A controller (not shown) may determine the selection or configuration of advertising in the streaming video based on any suitable algorithm or process. The video streaming system 800 may include other modules or units not depicted in FIG. 8, for example administrative servers, commerce servers, network infrastructure, advertising selection engines, and so forth.

The video streaming system 800 may connect to a data communication network 812. A data communication network 812 may comprise a local area network (LAN), a wide area network (WAN), for example, the Internet, a telephone network, a wireless cellular telecommunications network (WCS) 814, or some combination of these or similar networks.

One or more client devices 820 may be in communication with the video streaming system 800, via the data communication network 812 and/or other network 814. Such client devices may include, for example, one or more laptop computers 820-1, desktop computers 820-2, “smart” mobile phones 820-3, tablet devices 820-4, network-enabled televisions 820-5, or combinations thereof, via a router 818 for a LAN, via a base station 817 for a wireless telephony network 814, or via some other connection. In operation, such client devices 820 may send and receive data or instructions to the system 800, in response to user input received from user input devices or other input. In response, the system 800 may serve video segments and metadata from the data store 809 responsive to selection of media programs to the client devices 820. Client devices 820 may output the video content from the streaming video segment in a media player using a display screen, projector, or other video output device, and receive user input for interacting with the video content.

Distribution of audio-video data may be implemented from streaming component 807 to remote client devices over computer networks, telecommunications networks, and combinations of such networks, using various methods, for example streaming. In streaming, a content server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidths and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Streaming component 807 may communicate with client device 820 using control messages and data messages to adjust to changing network conditions as the video is played. These control messages can include commands for enabling control functions such as fast forward, fast reverse, pausing, or seeking to a particular part of the file at the client.

Since streaming component 807 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming component 807 may use TCP-based protocols, such as HTTP and Real Time Messaging Protocol (RTMP). Streaming component 807 can also deliver live webcasts and can multicast, which allows more than one client to tune into a single stream, thus saving bandwidth. Streaming media players may not rely on buffering the whole video to provide random access to any point in the media program. Instead, this is accomplished through the use of control messages transmitted from the media player to the streaming media server. Another protocol used for streaming is hypertext transfer protocol (HTTP) live streaming (HLS). The HLS protocol delivers video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and also infrastructure failures that may occur during playback of the video.

The delivery of video content by streaming may be accomplished under a variety of models. In one model, the user pays for the viewing of video programs, for example, using a fee for access to the library of media programs or a portion of restricted media programs, or using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

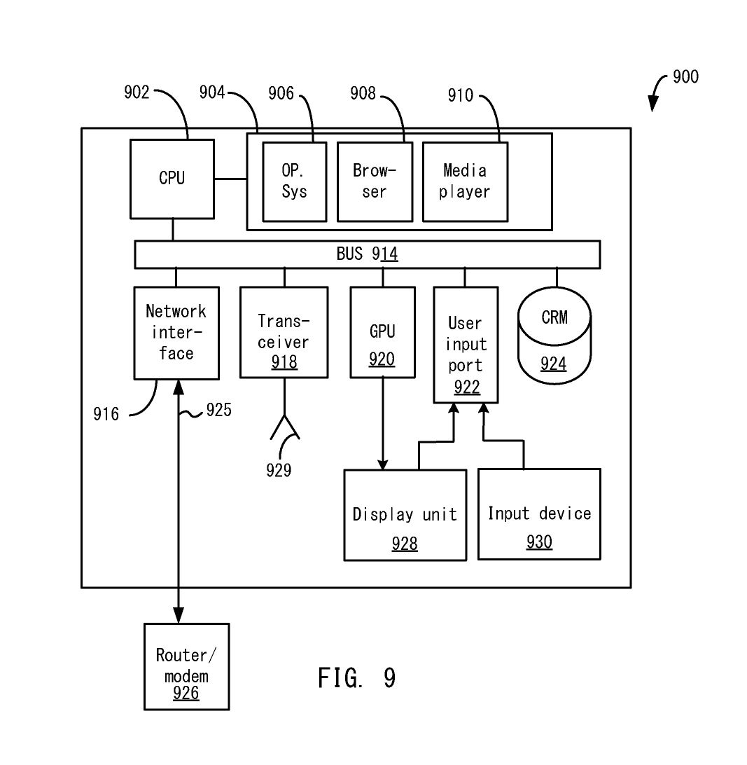

Referring to FIG. 9, a diagrammatic view of an apparatus 900 for viewing video content and advertisements is illustrated. In selected embodiments, the apparatus 900 may include a processor (CPU) 902 operatively coupled to a processor memory 904, which holds binary-coded functional modules for execution by the processor 902. Such functional modules may include an operating system 906 for handling system functions such as input/output and memory access, a browser 908 to display web pages, and media player 910 for playing video. The modules may further be able to request and display advertisement in advertisement slots. The memory 904 may hold additional modules not shown in FIG. 9, for example modules for performing other operations described elsewhere herein.

A bus 914 or other communication component may support communication of information within the apparatus 900. The processor 902 may be a specialized or dedicated microprocessor configured to perform particular tasks in accordance with the features and aspects disclosed herein by executing machine-readable software code defining the particular tasks. Processor memory 904 (e.g., random access memory (RAM) or other dynamic storage device) may be connected to the bus 914 or directly to the processor 902, and store information and instructions to be executed by a processor 902. The memory 904 may also store temporary variables or other intermediate information during execution of such instructions.

A computer-readable medium in a storage device 924 may be connected to the bus 914 and store static information and instructions for the processor 902; for example, the storage device (CRM) 924 may store the modules 906, 908, 910 and 912 when the apparatus 900 is powered off, from which the modules may be loaded into the processor memory 904 when the apparatus 900 is powered up. The storage device 924 may include a non-transitory computer-readable storage medium holding information, instructions, or some combination thereof, for example instructions that when executed by the processor 902, cause the apparatus 900 to be configured to perform one or more operations of a method as described herein.

A communication interface 916 may also be connected to the bus 914. The communication interface 916 may provide or support two-way data communication between the apparatus 900 and one or more external devices, e.g., the streaming system 900, optionally via a router/modem 926 and a wired or wireless connection. In the alternative, or in addition, the apparatus 900 may include a transceiver 918 connected to an antenna 929, through which the apparatus 900 may communicate wirelessly with a base station for a wireless communication system or with the router/modem 926. In the alternative, the apparatus 900 may communicate with a video streaming system 800 via a local area network, virtual private network, or other network. In another alternative, the apparatus 900 may be incorporated as a module or component of the system 900 and communicate with other components via the bus 914 or by some other modality.

The apparatus 900 may be connected (e.g., via the bus 914 and graphics processing unit 920) to a display unit 929. A display 928 may include any suitable configuration for displaying information to an operator of the apparatus 900. For example, a display 928 may include or utilize a liquid crystal display (LCD), touchscreen LCD (e.g., capacitive display), light emitting diode (LED) display, projector, or other display device to present information to a user of the apparatus 900 in a visual display.

One or more input devices 930 (e.g., an alphanumeric keyboard, microphone, keypad, remote controller, game controller, camera or camera array) may be connected to the bus 914 via a user input port 922 to communicate information and commands to the apparatus 900. In selected embodiments, an input device 930 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 928, for example using a touch sensitive screen. A cursor control device may communicate direction information and command selections to the processor 902 and control cursor movement on the display 928. A cursor control device may have two or more degrees of freedom, for example allowing the device to specify cursor positions in a plane or three-dimensional space.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method providing rate control for a first advertisement in a campaign, the method comprising:
calculating, by a computing device, a delivery pressure for a first advertisement in a list of advertisements that qualified for an advertisement slot in a media program, the delivery pressure based on a number of advertisement impressions in the campaign that is remaining, a share of voice for the first advertisement, and a volume of impressions that are remaining for the campaign;
determining, by the computing device, when the delivery pressure indicates a pressure to deliver the first advertisement is below a threshold;
adjusting, by the computing device, a status for an eligibility of the first advertisement to be delivered from a first state to a second state when the delivery pressure is below the threshold, wherein the first state does not enable rate control and the second state enables rate control to control delivery of the first advertisement due to the delivery pressure; and
selecting, by the computing device, at least one advertisement from the list of advertisements for the advertisement slot, wherein the selecting is performed with rate control enabled based on the first advertisement having the second state as the status.

2. The method of claim 1, wherein calculating the pressure comprises:
calculating the pressure as the number of advertisement impressions in the campaign that is remaining multiplied by the share of voice for the first advertisement to generate a first result, and dividing the first result by the volume of the first advertisement for the campaign remaining.

3. The method of claim 2, wherein calculating the pressure comprises:
multiplying the first result by a constant, and then dividing the first result by the volume of the first advertisement for the campaign remaining, wherein the constant is selected to smooth pacing of the first advertisement over a time period.

4. The method of claim 3, wherein calculating the pressure comprises:
using a calculation of P=(nRT)/V,
where n is the number of advertisement impressions in the campaign that is remaining, T is the share of voice for the first advertisement, R is the constant, and V is the volume of the first advertisement for the campaign remaining.

5. The method of claim 1, wherein the status is the second status, the method further comprising:
removing the first advertisement from being eligible to be selected from the list of advertisements a percentage of time over a time period.

6. The method of claim 1, wherein when having the second status, the first advertisement is still eligible to qualify for the list of advertisements, but not eligible to be selected.

7. The method of claim 1, wherein the threshold comprises a first threshold, the method further comprising:
determining when the delivery pressure indicates the pressure to deliver the first advertisement is above a second threshold; and
adjusting the status from the second state to the first state, wherein the first state disables the rate control.

8. The method of claim 7, wherein the second threshold is equal to or above the first threshold.

9. The method of claim 1, further comprising:
receiving an advertisement request for the advertisement slot located in the media program while a user is watching the media program, wherein the at least one advertisement is provided during the advertisement slot.

10. The method of claim 1, further comprising:
when the status is the second status, determining, for a time unit, an eligibility status indicating whether the first advertisement should be eligible for delivery; and
using the eligibility status in selecting the at least one advertisement from the list of advertisements.

11. The method of claim 10, wherein using the eligibility status comprises:
removing the first advertisement from being eligible for selection from the list of advertisements for that time unit.

12. The method of claim 11, further comprising:
when the status is the second status, continuing to determine, for subsequent time units, an eligibility status indicating whether the first advertisement should be eligible for delivery; and
using the eligibility status in selecting the at least one advertisement from the list of advertisements.

13. The method of claim 12, wherein over the subsequent time units, the eligibility status indicates the first advertisement is eligible and not eligible based on a value of the delivery pressure.

14. A non-transitory computer-readable storage medium containing instructions for providing rate control for a first advertisement in a campaign, wherein the instructions, when executed, control a computer system to be configured for:
calculating a delivery pressure for a first advertisement in a list of advertisements that qualified for an advertisement slot in a media program, the delivery pressure based on a number of advertisement impressions in the campaign that is remaining, a share of voice for the first advertisement, and a volume of impressions that are remaining for the campaign;
determining when the delivery pressure indicates a pressure to deliver the first advertisement is below a threshold;
adjusting a status for an eligibility of the first advertisement to be delivered from a first state to a second state when the delivery pressure is below the threshold, wherein the first state does not enable rate control and the second state enables rate control to control delivery of the first advertisement due to the delivery pressure; and
selecting at least one advertisement from the list of advertisements for the advertisement slot, wherein the selecting is performed with rate control enabled based on the first advertisement having the second state as the status.

15. The non-transitory computer-readable storage medium of claim 14, wherein calculating the pressure comprises:
calculating the pressure as the number of advertisement impressions in the campaign that is remaining multiplied by the share of voice for the first advertisement to generate a first result, and dividing the first result by the volume of the first advertisement for the campaign remaining.

16. The non-transitory computer-readable storage medium of claim 15, wherein calculating the pressure comprises:
multiplying the first result by a constant, and then dividing the first result by the volume of the first advertisement for the campaign remaining, wherein the constant is selected to smooth pacing of the first advertisement over a time period.

17. The non-transitory computer-readable storage medium of claim 16, wherein calculating the pressure comprises:
using a calculation of P=(nRT)/V,
where n is the number of advertisement impressions in the campaign that is remaining, T is the share of voice for the first advertisement, R is the constant, and V is the volume of the first advertisement for the campaign remaining.

18. The non-transitory computer-readable storage medium of claim 14, wherein the status is the second status, the method further comprising:
removing the first advertisement from being eligible to be selected from the list of advertisements a percentage of time over a time period.

19. The non-transitory computer-readable storage medium of claim 14, wherein when having the second status, the first advertisement is still eligible to qualify for the list of advertisements, but not eligible to be selected.

20. An apparatus for providing rate control for a first advertisement in a campaign, the apparatus comprising:
one or more computer processors; and
a non-transitory computer-readable storage medium comprising instructions, that when executed, control the one or more computer processors to be configured for:
for providing rate control for a first advertisement in a campaign, wherein the instructions, when executed, control a computer system to be configured for:
calculating a delivery pressure for a first advertisement in a list of advertisements that qualified for an advertisement slot in a media program, the delivery pressure based on a number of advertisement impressions in the campaign that is remaining, a share of voice for the first advertisement, and a volume of impressions that are remaining for the campaign;
determining when the delivery pressure indicates a pressure to deliver the first advertisement is below a threshold;
adjusting a status for an eligibility of the first advertisement to be delivered from a first state to a second state when the delivery pressure is below the threshold, wherein the first state does not enable rate control and the second state enables rate control to control delivery of the first advertisement due to the delivery pressure; and
selecting at least one advertisement from the list of advertisements for the advertisement slot, wherein the selecting is performed with rate control enabled based on the first advertisement having the second state as the status.
